(19) United States
(12) Patent Application Publication
(10) Pub. No.: US 2018/0201233 A1
(43) Pub. Date: Jul. 19, 2018

(54) PORTABLE VEHICLE WASH CONTAINER

(71) Applicant: Zakir HOSSAIN, Warren, MI (US)

(72) Inventor: Zakir HOSSAIN, Warren, MI (US)

(21) Appl. No.: 15/919,637

(22) Filed: Mar. 13, 2018

Related U.S. Application Data
(63) Continuation-in-part of application No. 15/239,449, filed on Aug. 17, 2016, now abandoned.

(51) Int. Cl. B60S 3/04; B08B 3/04

(52) U.S. Cl. CPC B60S 3/04; B08B 3/04

(57) ABSTRACT

A portable wash unit is provided by the present disclosure that includes a first container and a second container. The first container is detachably coupled to the second container and the first and second container forms a body when coupled. The portable wash unit further includes at least one fluid reservoir disposed within the body and a power supply device to power the fluid reservoir. In one form, the fluid reservoir includes a clean fluid reservoir and a waste fluid reservoir. The portable wash unit may further include a pair of pivotably attached doors and/or at least one ramp detachably connected to a passageway.

### CROSS-REFERENCE TO RELATED APPLICATIONS

This application is a continuation-in-part of and claims the benefit of U.S. Ser. No. 15/239,449, filed on Aug. 17, 2016 and titled, “PORTABLE VEHICLE WASH CONTAINER.” The contents of the above application are incorporated herein by reference in their entirety.

### FIELD

The present disclosure relates generally to vehicle washing units and more particularly to a vehicle wash container that can be easily transported.

### BACKGROUND

The statements in this section merely provide background information related to the present disclosure and may not constitute prior art.

Portable vehicle washing facilities travel to different locations and offer vehicle cleaning services to customers who may not otherwise have the time, patience, or access to stationary vehicle washing facilities. Access to portable vehicle washing facilities thus reduces the impatience and wasted time resulting from having to look for and travel to a stationary facility.

It is common for portable washing facilities to be confined within the body of a semi-truck or a trailer, which must comply with the various federal, state, and local highway ordinances, such as the size limits of the trailers. Therefore, the size of the washing facility is limited to the size of the trailer. However, the limited size is only capable of accommodating smaller vehicles and further provides for little or no room for a user to move about the vehicle to efficiently and completely wash the vehicle.

The issues associated with the limited size of washing facilities, compliance with highway ordinances, among other issues are addressed by the present disclosure.

### SUMMARY

In one form, the present disclosure provides a portable wash unit comprising a first container and a second container, wherein the first container is detachably coupled to the second container. When the first container is coupled to the second container, a body of the portable wash unit is defined. The portable wash unit further includes at least one fluid reservoir disposed within the body and a power supply device to power the at least one fluid reservoir.

In another form of the present disclosure, a portable wash unit is provided and includes a first container detachably coupled to the second container. The first container and second container form a body having a first access side defining a passage and a front side including a pair of solid end panels. The portable wash unit further includes at least one fluid reservoir disposed within the body and a power supply device to power the at least one fluid reservoir.

In yet another form of the present disclosure, a portable wash unit is provided and includes a first container detachably coupled to the second container. The first container and second container form a body having a first access side defining a passage and a first passage and a second access side defining a second passage. The portable wash unit further includes at least one fluid reservoir disposed within the body and a power supply device to power the at least one fluid reservoir.

In one variation of the various forms of the portable wash unit, the first and second containers are shipping containers manufactured in conformity with the International Organization for Standardization (ISO) specifications. Therefore, the first and second shipping containers each define a length of 20 ft. or 40 ft., a width of 8 ft. and a height of 8 ft. 6 in.

The fluid reservoir, in another variation, is a clean fluid reservoir comprising a pressure hose that is powered by the power supply device. In another form, the fluid reservoir is a waste fluid reservoir comprising a vacuum hose that is powered by the power supply device. A waste receptacle in fluid communication with the waste fluid reservoir may be provided in which the waste receptacle is disposed on a floor of the body that is beneath a vehicle when a vehicle is in the portable wash unit. However, the portable wash unit may also include both the clean fluid reservoir and the waste fluid reservoir. Furthermore, the at least one fluid reservoir may also include at least one of a soap reservoir, an oil reservoir, a wax reservoir, and a chemical reservoir.

In other various forms, the portable car unit may include one or more locking devices to temporarily secure the first and second containers together and/or at least one ramp secured to a first access side, a second access side, or both the first and second access side. A pair of doors may be pivotably attached to the first and second container at the first access side and/or the second access side of the body.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is front perspective view of a portable wash unit constructed in accordance with the present disclosure;

FIG. 2 is a top perspective view of a first container according to the present disclosure; and

FIG. 3 is a top perspective view of a second container according to the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

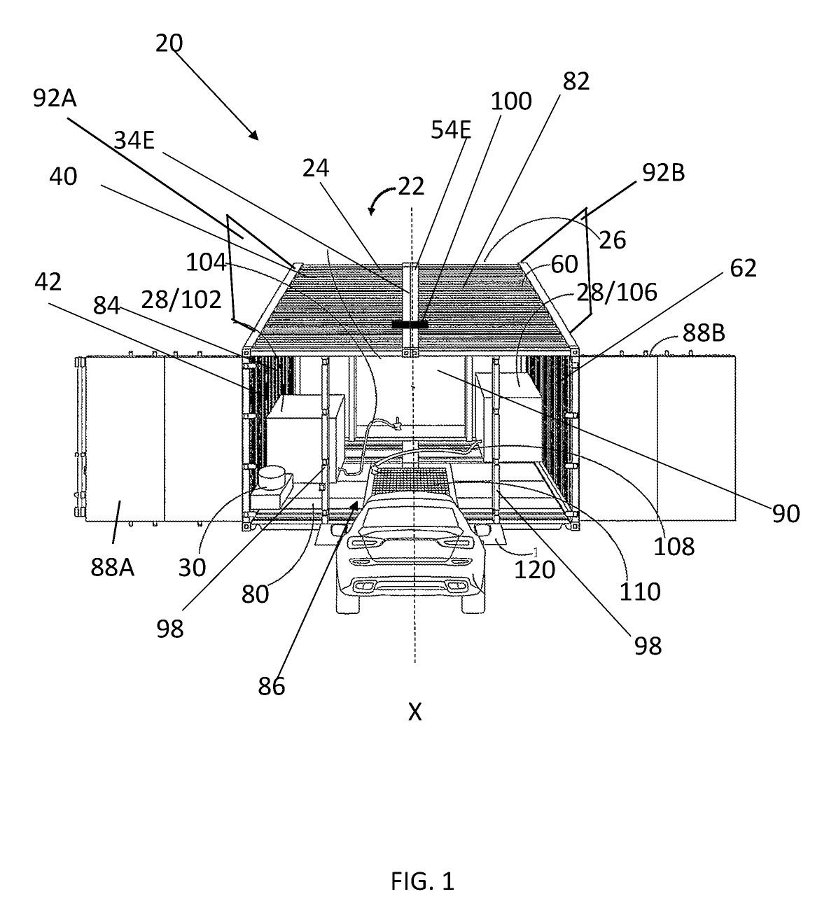

Referring to FIG. 1, a portable wash unit to manually wash a motorized vehicle or mode of transportation according to the principles of the present disclosure is illustrated and generally indicated as reference numeral 20. The portable wash unit 20 comprises a body 22 including a first container 24, a second container 26 that is detachably coupled to the first container 24, at least one fluid reservoir 28, and a power supply device 30. In one form, the first and second containers 24, 26 are symmetrical about a horizontal axis X of the body 22.

In one form, the first and second containers 24, 26 of the body 22 are shipping containers that are manufactured in conformity with the International Organization for Standardization (ISO) specifications in terms of height, width, and length of each shipping container 24, 26. Various federal, state, and local highway ordinances implement size limits of trailers that transport shipping containers and thus, shipping containers are usually manufactured with dimensions to comply with the highway ordinances. For example, ISO Standard 668 specifies external dimensions of shipping containers, intended for international use, are generally 20 ft. or 40 ft. in length, 8 ft. in width, and 8 ft. 6 in. in height. Therefore, this configuration allows the portable wash unit 20 to comply with the various federal, state, and local highway ordinances in terms of transportation restrictions when the portable wash unit 20 is being transported from one location to the next. Although the external dimensions of each shipping container 24, 26 is illustrated and described herein as conforming with the external dimensions specified under ISO Standard 668, it should be understood that the shipping containers 24, 26 are not limited to these specific dimensions and the shipping containers 24, 26 may define any external dimensions, such as for example an external length, width, and height that conform with standard shipping containers used domestically in the United States, while still remaining within the scope of the present disclosure.

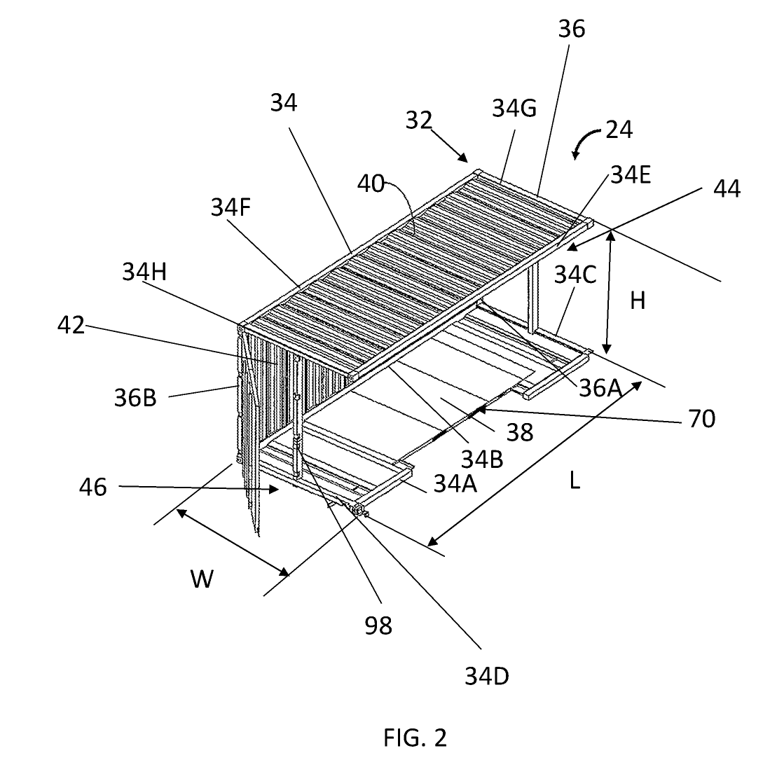

Referring to FIG. 2, in one form, the first container 24 of the body 22 defines a 20 ft. ISO standard shipping container, thus, the first container 24 is 20 ft. in length L, 8 ft. in width W, and 8 ft. 6 in. in height H. The first container 24 comprises a frame 32 having a plurality of horizontal beams 34 and a plurality of vertical beams 36. The horizontal beams 34 (i.e., 34A, 34B, 34C, 34D, 34E, 34F, 34G in figures) and vertical beams 36 (i.e., 36A, 36B in figures) of the frame 32 are connected together to define the edges of the first container 24 and further provides the strength and support of the first container 24. The first container 24 further includes a bottom section 38, a top section 40, a side section 42, a back section 44, and a front section 46.

The bottom section 38, top section 40, side section 42, back section 44, and front section 46 of the first container 24 are positioned between the plurality of horizontal and vertical beams 34, 36 of the frame 32. More specifically, the bottom section 38 is positioned between an inner horizontal beam 34A, an outer horizontal beam 34B, a front horizontal beam 34C, and a back horizontal beam 34D. The top section 40 is positioned between an inner horizontal beam 34E, an outer horizontal beam 34F, a front horizontal beam 34G, and a back horizontal beam 34H. The side section 42 is positioned between the outer horizontal beams 34B, 34F, a front vertical beam 36A, and a back vertical beam 36B. The back section 44 is positioned between the back horizontal beams 34D, 34H, and the back vertical beam 36B. The front section 46 is positioned between the front horizontal beams 34C, 34G and the front vertical beam 36A.

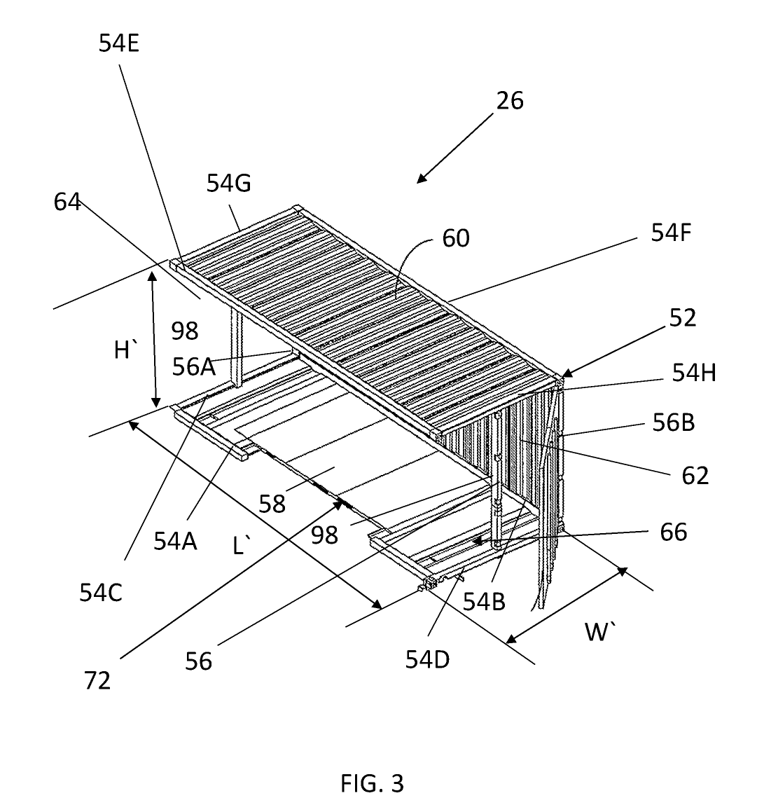

Referring to FIG. 3, in one form, the second container 26 of the body 22 is 20 ft. in length IL′, 8 ft. in width W′, and 8 ft. 6 in. in height H′. The second container 26 comprises a frame 52 having a plurality of horizontal beams 54 (i.e., 54A, 54B, 54C, 54D, 54E, 54F, 54G in figures.) and a plurality of vertical beams 56 (i.e., 56A, 56B in figures). Similar to the first container 24, the horizontal beams 54 and vertical beams 56 of the frame 52 are connected together to define the edges of the second container 26 and further provides the strength and support of the second container 26. The second container 26 further comprises a bottom section 58, a top section 60, a side section 62, a back section 64, and a front section 66.

The bottom section 58, top section 60, side section 62, back section 64, and front section 66 of the second container 26 are positioned between the plurality of horizontal and vertical beams 54, 56 of the frame 52. More specifically, the bottom section 58 is positioned between an inner horizontal beam 54A, an outer horizontal beam 54B, a front horizontal beam 54C, and a back horizontal beam 54D. The top section 60 is positioned between an inner horizontal beam 54E, an outer horizontal beam 54F, a front horizontal beam 54G, and a back horizontal beam 54H. The side section 62 is positioned between the outer horizontal beams 54B, 54F, a front vertical beam 56A, and a back vertical beam 56B. The back section 64 is positioned between the back horizontal beams 54C, 54G, and the back vertical beam 56A. The front section 66 is positioned between the front horizontal beams 54D, 54H and the front vertical beam 56B.

It should be understood that the frame 32, 52 of the first container 24 and the second container 26 may include any number of horizontal beams 34, 54 and vertical beams 36, 56 while still remaining within the scope the present disclosure.

The first container defines one or more slots 70 (FIG. 2) and the second container 26 defines one or more slots 72 (FIG. 3). The slots 70 and 72 are configured to attach to a feature of a lifting mechanism, such as forks of a forklift or hooks of a crane. Once attached, the lifting mechanism is operable to load and unload the shipping containers 24, 26 on, for example, a truck trailer, railroad cart, or ship, which transports the shipping containers 24, 26 from one place to another.

Referring back to FIG. 1, the first container 24 and second container 26 are detachably coupled to form the body 22 of the portable wash unit 20. More particularly, in one form, the inner horizontal beams 34A, 34E of the first container 24 and the inner horizontal beams 54A, 54E of the second container 26 are configured to engage and disengage with each other to couple and decouple the first and second containers 24 and 26.

When coupled, the bottom section 38 of the first container 24 and the bottom section 58 of the second container 26 form a floor 80 of the body 22 and is configured to support a load, such as the weight of a vehicle. In addition, the top section 40 of the first container 24 and the top section 60 of the second container 26 form a roof 82 of the body 22, and the side section 42 of the first container 24 and the side section 62 of the second container 26 form the outer sides 84 of the body 22. Therefore, the portable wash unit 20 defines an external width of 16 ft. and provides ample space for the user and the vehicle within the portable wash unit 20.

In one form, the back sections 44 and 64 of the first and second container 24 and 26, and the front section 46 and 66 of the first and second containers 24 and 26 are configured as access ways for a vehicle to enter/exit the unit 20. For example, the back section 44 and the back section 64 form a first access side 86 of the body 22 that defines a passage 86 of the portable wash unit 20 for facilitating entry and/or exit of the vehicle. In one form, the first container 24 includes a door 88A that is pivotably attached at the back section 44 and the second container 26 includes a door 88B that is pivotably attached at the back section 64. The doors 88A and 88B are operable to lock together and close the first access side 86 when engaged. When the doors 88A and 88B are in an open position (FIG. 1), the vehicle can enter and exit the portable wash unit 20 through the first access side 86.

Furthermore, the front section 46 of the first container 24 and the front section 66 of the second container 26 form a second access side 90 of the body 22 that defines a passage 90 of the portable wash unit 20 for facilitating entry and/or exit of the vehicle. In one form, the first container 24 includes a door 92A that is pivotably attached at the front section 46, and the second container 26 includes a door 92B that is pivotably attached at the front section 66. The doors 92A and 92B are operable to lock together and close the front passage 90 when engaged. When the doors 92A and 92B are in an open position (FIG. 1), the vehicle can enter and exit the portable wash unit 20 through the second access side 90.

In this form, the vehicle can enter the portable wash unit 20 through one passage 86, 90 and exit through the other passage 86, 90. For example, the vehicle can enter the first access side 86 and exit through the second access side 90 or the vehicle can enter through the second access side 90 and exit through the first access side 86. This configuration allows vehicles to form a line without having to keep a distance between the portable wash unit 20 and next vehicle in line because the vehicle being washed in the portable wash unit 20 will not have to reverse the vehicle out of the portable wash unit 20 to exit. This efficient, uniform, and one-way movement of vehicles through the portable wash unit 20 increases productivity and profits.

In another form, the second access side 90 of the portable wash unit 20 includes a pair of solid end panels, where one end panel is secured to the front horizontal beams 34C, 34G of the first container 24 and the other end panel is secured to the front horizontal beams 54C, 54G of the second container 26. In this form, the second access side 90 is closed and only the first access side 86 is available for the vehicles to enter and exit the portable wash unit 20. This configuration may be desirable when the portable wash unit 20 is transported to a location that does not provide enough space for the vehicle to enter the first access side 86 and exit the second access side 90 or vice versa.

As shown in FIGS. 1-3, in one form, the portable wash unit 20 may include additional vertical beams 98 at the backend 86 and the frontend 90 of the body 22 for additional support. Each vertical beam 98 is positioned between one of the outer-sides 84 of the body 22 and the inner horizontal beams 34A, 34E, 54A, 54E. The additional vertical beams 98 are positioned at a distance sufficient to provide enough space for the vehicle to pass between the vertical beams 98.

In another form, the portable wash unit 20 further includes at least one locking device 100 configured to temporarily secure the first container 24 and the second container 26 together. The locking device 100 includes two opposing sides where one side mounted to the first container 24 at a predetermined location lockingly engages with the opposing side that is mounted to an adjacent location on the second container 26. In one example, the locking device 100 is mounted to the top sections 40, 60 of the first container 24 and the second container 26. The locking device 100 is not limited to any specific configuration and may be any suitable device configured to temporarily secure the first and second containers 24, 26 together, such as, a pull handle and lock assembly, a turn handle and lock assembly, and/or a deadbolt, among others, while still remaining within the scope of the present disclosure.

At least one of the fluid reservoirs 28 is a clean fluid reservoir 102 comprising a pressure hose 104 for supplying clean fluid to wash the vehicle. In other variations, the fluid reservoir 28 may be a soap reservoir, oil reservoir, wax reservoir, and/or a chemical reservoir, among others.

In another form, the fluid reservoir 28 further includes a waste fluid reservoir 106 comprising a vacuum hose 108. In this form, the waste fluid reservoir 106 may be in fluid communication with a waste receptacle 110 that transfers the waste fluid from the waste receptacle 110 to the waste fluid reservoir 106. As illustrated in FIG. 1, the waste receptacle 110 is disposed in a central location of the floor 80 such that when a vehicle is in the portable wash unit 20, the waste receptacle 110 is positioned beneath the vehicle.

The power supply device 30 provides power to the pressure hose 104 of the clean fluid reservoir 102 and to the vacuum hose 108 of the waste fluid reservoir 106. In one form, the power supply device 30 is a power generator, solar panels, a battery, and/or an electrical outlet. It should be understood that the power supply device 30 may be any power source while still remaining within the scope of the present disclosure.

In yet another form of the present disclosure, the portable wash unit 20 further includes at least one ramp 120 extending from at least one of the back passage 86 and the front passage 90 to the ground in a sloping manner. The ramp 120 is adapted to receive wheels of the vehicle and the vehicle travels along the ramp 120 to enter or exit the portable wash unit 20. In one form, the ramp 120 is hingedly attached to the portable wash unit 20. Alternatively, the ramp 120 may extend from a cavity defined by the portable wash unit 20 or be in the form of a wedge. The ramp 120 is not limited to these specific configurations, and any ramp may be employed while still remaining within the scope of the present disclosure.

When shipping the portable wash unit 20 from one location to the next, the first and second shipping containers 24, 26 are in a detached state. The various components, such as the fluid reservoirs 28, the power supply device 30, and the ramps 120 may be shipped separately or may be shipped within at least one of the containers. When the various components are shipped within one of the containers 24, 26, the components are secured to reduce movement and inhibit the components from exiting the containers 24, 26. In one example, a removable commercial tarp is installed on an inner side of each container 24, 26 to further inhibit the components from exiting the containers 24, 26. It should be understood that any securing device may be employed to secure the various components while still remaining within the scope of the present disclosure.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A portable wash unit comprising:
a first container and a second container, wherein the first container is detachably coupled to the second container, and the first container and second container defining a body;
at least one fluid reservoir disposed within the body; and
a power supply device to power the at least one fluid reservoir.

2. The portable wash unit of claim 1, wherein the at least one fluid reservoir is a clean fluid reservoir comprising a pressure hose that is powered by the power supply device.

3. The portable wash unit of claim 1, wherein the at least one fluid reservoir is a waste fluid reservoir comprising a vacuum hose that is powered by the power supply device.

4. The portable wash unit of claim 3 further comprising a waste receptacle in fluid communication with the waste fluid reservoir.

5. The portable wash unit of claim 4, wherein the waste receptacle is disposed on a floor of the body.

6. The portable wash unit of claim 1, wherein each of the first and second containers define a length of 20 ft. or 40 ft., a width of 8 ft. and a height of 8 ft. 6 in.

7. The portable wash unit of claim 1 further comprising at least one locking device to temporarily secure the first and second containers together.

8. The portable wash unit of claim 1 further comprising at least one ramp.

9. A portable wash unit comprising:
a first container detachably coupled to a second container, wherein the first container and second container form a body, and the body comprises a first access side defining a passage and a front side including a pair of solid end panels;
at least one fluid reservoir disposed within the body; and
a power supply device to power the at least one fluid reservoir.

10. The portable wash unit of claim 9 further comprising a pair of doors pivotably attached to the first and second container at the first access side of the body.

11. The portable wash unit of claim 9 further comprising at least one ramp detachably connected to the first access side passage.

12. The portable wash unit of claim 9, wherein the at least one fluid reservoir is at least one of a clean fluid reservoir, a waste fluid reservoir, a soap reservoir, an oil reservoir, a wax reservoir, and a chemical reservoir.

13. The portable wash unit of claim 9, wherein the at least one fluid reservoir is a clean fluid reservoir comprising a pressure hose that is powered by the power supply device.

14. The portable wash unit of claim 9, wherein the at least one fluid reservoir is a waste fluid reservoir comprising a vacuum hose that is powered by the power supply device.

15. The portable wash unit of claim 9 further comprising a waste receptacle disposed on a floor of the body, wherein the waste receptacle is in fluid communication with the waste fluid reservoir.

16. The portable wash unit of claim 9, wherein each of the first and second containers define a length of 20 ft. or 40 ft., a width of 8 ft. and a height of 8 ft. 6 in.

17. A portable wash unit comprising:
a first container detachably coupled to a second container, the first container and second container form a body, wherein the body comprises a first access side defining a first passage and a second access side defining a second passage;
a clean fluid reservoir having a pressure hose disposed in the body;
a waste fluid reservoir having a vacuum hose disposed in the body; and
a power supply device to power the pressure hose and vacuum hose.

18. The portable wash unit of claim 17 further comprising a pair of doors pivotably attached to the first and second container on at least one of the first access side or the second access side of the body.

19. The portable wash unit of claim 17 further comprising at least one ramp detachably connected to at least one of the first access side or the second access side of the body.

20. The portable wash unit of claim 17, wherein each of the first and second containers define a length of 20 ft. or 40 ft., a width of 8 ft. and a height of 8 ft. 6 in.
